(19) United States
(12) Patent Application Publication
(10) Pub. No.: US 2024/0248109 A1
(43) Pub. Date: Jul. 25, 2024

(54) AUTOMATIC ANALYZER

(71) Applicant: CANON MEDICAL SYSTEMS CORPORATION, Otawara-shi (JP)

(72) Inventors: Yoshihiro JIFUKU, Nasushiobara (JP); Shohei KAWASHIMA, Nasushiobara (JP); Tamaki HONDA, Nasushiobara (JP); Masakazu KITAMURA, Nasushiobara (JP); Gaku UENO, Nasushiobara (JP)

(73) Assignee: CANON MEDICAL SYSTEMS CORPORATION, Otawara-shi (JP)

(21) Appl. No.: 18/533,708

(22) Filed: Dec. 8, 2023

(30) Foreign Application Priority Data
Dec. 8, 2022 (JP) 2022-196527

(51) Int. Cl. G01N 35/10

(52) U.S. Cl. CPC G01N 35/1004

(57) ABSTRACT

An automatic analyzer includes a probe, a cleaner, and a controller. The probe includes a detector for detecting a contact with a liquid. The probe sucks and discharges the liquid. The cleaner cleans an outer wall of the probe with a cleaning fluid. The controller causes the detector to perform a detection during cleaning by the cleaner, and judges a state of the cleaner based on a result of the detection.

### CROSS REFERENCE TO RELATED APPLICATIONS

This application is based upon and claims the benefit of priority from the prior Japanese Patent Application No. 2022-196527, filed on Dec. 8, 2022, the entire contents of which are incorporated herein by reference.

### FIELD

Embodiments disclosed herein and the drawings relate to an automatic analyzer.

### BACKGROUND

Automatic analyzers for performing qualitative or quantitative analyses of samples such as blood or urine are known. In an automatic analyzer, a probe is inserted into a reagent container or a sample container to suck a fluid such as a reagent or a sample contained in the reagent container or the sample container, and the fluid is dispensed to a reaction container held by a reaction disk. At this time, the fluid may adhere to an outer wall at a tip portion of the probe. If a further sucking or discharging operation is performed for a next fluid, the fluid adhering to the outer wall of the tip portion of the probe may be mixed into the next fluid, which causes an adverse effect on an analysis result. Therefore, the probe is cleaned every time a sucking or discharging operation of a fluid using the probe is finished, or as the necessity for cleaning arises.

The cleaner has a discharge port, through which a cleaning fluid including water, a cleaning material, or the like is discharged. The probe is cleaned by the cleaning fluid discharged from the discharge port in the cleaner. In order to obtain an expected cleaning effect in cleaning the probe, the cleaning fluid needs to be discharged normally. Conventionally, whether a cleaning fluid is discharged normally in a cleaner has been judged visually by an operator (user). However, since the cleaning fluid discharged from the discharge port is often transparent, and the discharge port for discharging the cleaning fluid is likely to be disposed at a location deep inside the cleaner, which is difficult to see, it has been difficult for the operator to visually judge whether the cleaning fluid is discharged normally.

In order to suitably dispense the fluid such as a reagent or a sample into the reaction container, the reaction container and the probe need to be suitably aligned with each other. If a misalignment occurs to the probe, the discharge position of the probe changes, which may affect an analysis result. Therefore, when a qualitative or quantitative analysis of a sample is performed using the automatic analyzer, it is necessary to check whether a misalignment occurs to the probe. However, conventionally, the position of the probe has been visually checked by an operator, and therefore it has been difficult to determine an accurate position.

One of the problems to be solved by the embodiments disclosed herein or the accompanying drawings is to judge the state of the cleaner or the position of the probe in an automatic analyzer without relying on the visual judgement of the operator. The problems, however, are not limited only to the aforementioned problem. More than one problem may also be raised in association with an effect provided by each feature in the embodiments described below.

### BRIEF DESCRIPTION OF THE DRAWINGS

FIG. 1 is a block diagram showing an example of a configuration of an automatic analyzer.

FIG. 2 illustrates an example of functions of an analysis controller of the automatic analyzer.

FIG. 3 illustrates an example of a configuration of an analysis executor of the automatic analyzer.

FIG. 4 is a block diagram showing an example of the configuration of a cleaner of the automatic analyzer.

FIG. 5 illustrates an example of a cleaning chamber of the cleaner.

FIG. 6 is a diagram for explaining a method for cleaning a probe in the cleaner.

FIG. 7 is a flowchart showing an operation for detecting a cleaning fluid discharge position in the vertical direction according to a first embodiment.

FIG. 8 is a diagram for explaining the operation for detecting the cleaning fluid discharge position in the vertical direction according to the first embodiment.

FIG. 9 is a flowchart showing an operation for detecting a cleaning fluid discharge position in the horizontal direction according to the first embodiment.

FIG. 10 is a diagram for explaining the detection of the cleaning fluid discharge position in the horizontal direction according to the first embodiment.

FIG. 11 is a flowchart showing an operation for detecting a cleaning fluid discharge position in the vertical direction according to a second embodiment.

FIG. 12 is a flowchart showing an operation for detecting a cleaning fluid discharge position in the horizontal direction according to the second embodiment.

FIG. 13 is a flowchart showing the operation for detecting the cleaning fluid discharge position in the horizontal direction according to the second embodiment.

FIG. 14 is a flowchart showing a process for detecting a position of a probe in the horizontal direction according to a third embodiment.

FIG. 15 is a diagram for explaining a detection of a probe position in the horizontal direction according to the third embodiment.

### DETAILED DESCRIPTION

Embodiments will now be described with reference to the accompanying drawings. The scaling and the ratio between dimensions of an element may be different from those of the actual element in each drawing, for the easy understanding and the convenience of illustration.

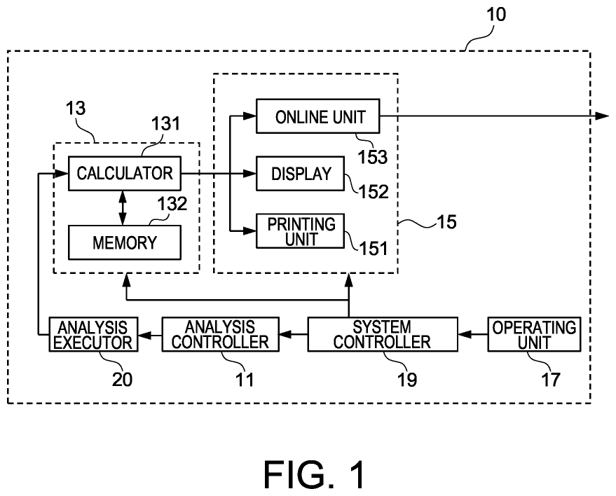

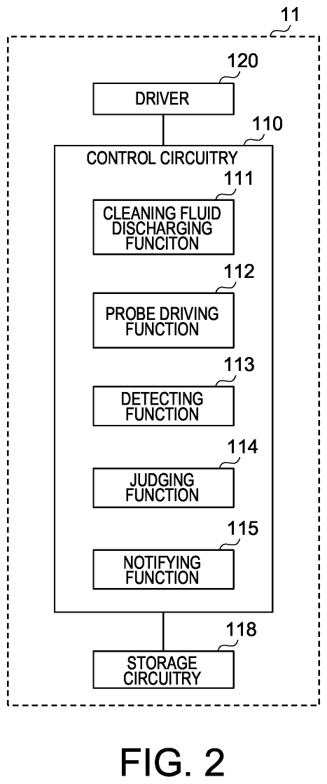

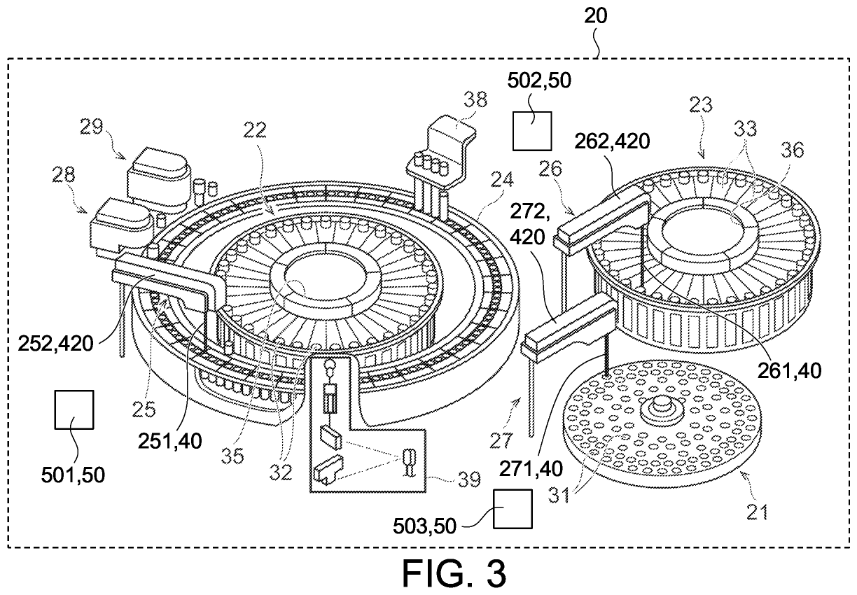

FIG. 1 is a block diagram showing an example of a configuration of an automatic analyzer 10. FIG. 2 is a diagram showing an example of functions of an analysis controller 11 of the automatic analyzer 10. FIG. 3 is a diagram showing an example of a configuration of an analysis executor 20 of the automatic analyzer 10.

The automatic analyzer 10 includes the analysis executor 20, the analysis controller 11, an analysis data processor 13, an output unit 15, an operating unit 17, and a system controller 19. The analysis executor 20 measures and analyzes a sample to be tested and a calibrator. The analysis controller 11 controls the analysis executor 20. The analysis data processor 13 processes an analysis signal outputted from the analysis executor 20 to calculate analysis data. The output unit 15 outputs the analysis data sent from the analysis data processor 13. The operating unit 17 receives inputs of analysis conditions and command signals. The system controller 19 controls the above-described components.

The analysis data processor 13 includes a calculator 131 that produces a calibration table from such signals as a calibration signal and an analysis signal outputted from the analysis executor 20 and calculates analysis data, and a memory 132 that stores the calibration table produced by the calculator 131 and the analysis data calculated by the calculator 131.

The calculator 131 produces a calibration table of each item based on a calibration signal relating to each item outputted from the analysis executor 20, and outputs the calibration table to the output unit 15 and also stores the calibration table in the memory 132. Furthermore, the calculator 131 reads out a calibration table from the memory 132, the calibration table corresponding to an item of the analysis signal outputted from the analysis executor 20, and calculates analysis data using the calibration table and outputs the analysis data to the output unit 15 and also stores the analysis data in the memory 132.

The memory 132 includes a hard disk, for example, and stores the calibration table and the analysis data for each sample to be tested outputted from the calculator 131.

The output unit 15 includes a printing unit 151 that prints and outputs the calibration table and the analysis data outputted from the analysis data processor 13, a display 152 that displays and outputs the calibration table and the analysis data, and an online unit 153 that outputs the analysis data to an external system such as an information system. The printing unit 151 includes a printer, and prints the calibration table and the analysis data outputted from the analysis data processor 13 on a sheet of printing paper based on a predetermined format. The display 152 includes a monitor such as a cathode ray tube (CRT), a liquid crystal display monitor, or an organic EL display monitor, and displays the calibration table and the analysis data outputted from the analysis data processor 13, and also displays a window used for the setting of the analysis conditions as instructed by the system controller 19.

The operating unit 17 includes an input device such as a keyboard, a mouse device, buttons, or a touch panel. As a result of an input, analysis conditions may be set, information of an object to be tested such as the ID and the name of the object to be tested may be inputted, measurement items for each sample to be tested of the object to be tested may be selected, and various operations such as a calibration of each item and an analysis of each sample to be tested may be performed.

The system controller 19 includes a CPU and storage circuitry. After storing information such as a command signal of an operator supplied from the operating unit 17, analysis conditions, information of the object to be tested, and measurement items of each sample to be tested, the system controller 19 performs the control of the entire system such as the control of the respective components of the analysis executor 20 to operate in a predetermined cycle of a predetermined sequence, and the control relating to the generation of a calibration table and the calculation and output of the analysis data.

The analysis executor 20 analyzes samples. In particular, the analysis executor 20 generates blank data using blank measurement, reference data using reference measurement for measuring a mixed solution including a reference sample for each test item and a reagent used in the analysis for each test item, and test data using measurement of a mixed solution including a sample to be tested and the reagent. The analysis executor 20 includes a sample disk 21, a reagent carousel 22, a reagent carousel 23, a reaction disk 24, a first reagent dispenser 25, a second reagent dispenser 26, a sample dispenser 27, a first agitation mechanism 28, and a second agitation mechanism 29.

The sample disk 21 includes a plurality of sample containers 31, each of which contains a sample such as a reference sample or a sample to be tested, for example blood serum. The sample containers 31 are mounted on a sample rack, for example, and stored in the sample disk 21. One sample rack may have one or more sample containers 31.

The reagent carousel 22 includes a reagent rack 35 that stores a plurality of reagent containers 32 in a rotatable manner. The reagent rack 35 stores and cools a first reagent contained in the reagent containers 32. The first reagents in the reagent containers 32 are of a one-reagent system or two-reagent system, for example, and react with a component of a test item included in the sample such as a reference sample or a sample to be tested. The reagent carousel 23 includes a reagent rack 36 that stores a plurality of reagent containers 33 in a rotatable manner. The reagent rack 36 stores and cools a second reagent contained in the reagent containers 33. Each reagent container 33 thus contains the second reagent that is used with the first reagent. The reagent rack 35 may store both the reagent containers 32 containing the first reagent and the reagent containers 33 containing the second reagent.

The reaction disk (transporter) 24 has a plurality of fixing tools that are detachably attached on the circumference of the reaction disk 24. The fixing tools hold a plurality of reaction containers at predetermined intervals on the circumference of the reaction disk 24. Thus, the reaction disk 24 includes the fixing tools for fixing the reaction containers, and holds the reaction containers in a movable manner.

The first reagent dispenser 25 includes a first reagent dispensing probe 251 (probe 40), a first arm 252 (arm 420), and a first cleaning mechanism 501 (cleaner 50). The first reagent dispensing probe 251 is used for a dispensing operation including a suction of the first reagent in one of the reagent containers 32 stored in the reagent rack 35 and a discharge of the first reagent into the reaction containers to which the sample is discharged. The first arm 252 holds the first reagent dispensing probe 251 in a rotatable and vertically movable manner. The first cleaning mechanism 501 is used for cleaning the first reagent dispensing probe 251 every time the dispensing from the first reagent dispensing probe 251 is finished for one of the reagents.

The second reagent dispenser 26 includes a second reagent dispensing probe 261 (probe 40), a second arm 262 (arm 420), and a second cleaning mechanism 502 (cleaner 50). The second reagent dispensing probe 261 is used for a dispensing operation including a suction of the second reagent in one of the reagent containers 33 stored in the reagent rack 36, and a discharge of the second reagent into the reaction containers to which the first reagent is discharged. The second arm 262 holds the second reagent dispensing probe 261 in a rotatable and vertically movable manner. The second cleaning mechanism 502 is used for cleaning the second reagent dispensing probe 261 every time the dispensing of one of the reagents from the second reagent dispensing probe 261 is finished.

The sample dispenser 27 includes a sample dispensing probe 271 (probe 40), a third arm 272 (arm 420), and a third cleaning mechanism 503 (cleaner 50). The sample dispensing probe 271 is used for a dispensing operation including a suction of the sample in one of the sample containers 31 stored in the sample disk 21, and a discharge of the sample into the reaction containers. The third arm 272 holds the sample dispensing probe 271 in a rotatable and vertically movable manner. The third cleaning mechanism 503 is used for cleaning the sample dispensing probe 271 every time the dispensing from the sample dispensing probe 271 is finished for one of the samples.

Herein, each of the first reagent dispensing probe 251, the second reagent dispensing probe 261 and the sample dispensing probe 271 may be called a probe 40. The “probe 40” thus indicates the first reagent dispensing probe 251, the second reagent dispensing probe 261 or the sample dispensing probe 271. Furthermore, each of the first arm 252, the second arm 262, and the third arm 272 may be called an arm 420. The “arm 420” thus indicates the first arm 252, the second arm 262, or the third arm 272. Moreover, each of the first cleaning mechanism 501, the second cleaning mechanism 502, and the third cleaning mechanism 503 may be called a cleaning mechanism (cleaner) 50. The “cleaning mechanism (cleaner) 50” thus indicates the first cleaning mechanism 501, the second cleaning mechanism 502 or the third cleaning mechanism 503. The details of the cleaner 50 will be described later.

The first agitation mechanism 28 includes an agitator, an arm, and a cleaning pool. The agitator agitates a mixed solution including the sample and the first reagent that have been dispensed to the reaction container. The arm holds the agitator in a rotatable and vertically movable manner. The cleaning pool is used for cleaning the agitator every time the agitation of the mixed solution is finished.

The second agitation mechanism 29 includes an agitator, an arm, and a cleaning pool. The agitator agitates a mixed solution including the sample, the first reagent, and the second reagent that have been dispensed to the reaction container. The arm holds the agitator in a rotatable and vertically movable manner. The cleaning pool is used for cleaning the agitator every time the agitation of the mixed solution is finished.

The automatic analyzer 10 further includes a reaction container cleaner 38 and a measuring unit 39. The measuring unit 39 measures light passing through the reaction container containing a fluid such as water or a mixed solution. The reaction container cleaner 38 performs a cleaning operation for cleaning and drying the inside of the reaction container for which the measuring unit 39 has finished the measurement of the mixed solution. The reaction container cleaner 38 also pours a blank fluid such as pure water to the cleaned reaction container for blank measurement.

The measuring unit 39 generates blank data by performing a blank measurement for detecting light passing through the reaction container to which the blank fluid has been dispensed. The measuring unit 39 also generates reference data by performing a reference measurement for detecting the light passing through the mixed solution including the reference sample and the reagent in the reaction container. The measuring unit 39 further generates test data by performing a test measurement on the light passing through the mixed solution including the sample to be tested and the reagents in the reaction container.

The analysis controller 11 controls the respective components of the analysis executor 20. For example, the analysis controller 11 sequentially assigns test items to the reaction containers that have been cleaned through a cleaning operation performed by the reaction container cleaner 38. The test items are selected for respective sample to be tested and inputted. The analysis controller 11 then causes the reaction container cleaner 38 to pour a blank fluid to the reaction containers to which the test items have been assigned. The amount of the blank fluid corresponds to the sum of the amount of the dispensed sample and the amount of the dispensed reagents. Subsequently, the analysis controller 11 causes the measuring unit 39 to perform a blank measurement of the reaction containers containing the blank fluid, thereby generating blank data.

The analysis controller 11 incudes control circuitry 110, storage circuitry 118, and a driver 120. The control circuitry 110 controls the driver 120 to drive the analysis executor 20. The driver 120 includes, for example, a gear, a stepping motor, a belt conveyor system, and a lead screw. For example, the driver 120 separately rotates the sample disk 21, the reagent rack 35, and the reagent rack 36 to move the sample container 31, the reagent container 32, and the reagent container 33. The driver 120 rotatably drives the transporter (reaction disk) 24 to move the reaction containers. The driver 120 also separately drives the respective arms 420 (252, 262, and 272) vertically and rotatably to move the probes 40 (251, 261, and 271).

The storage circuitry 118 stores a program for at least performing a function of the control circuitry 110. In addition to such a program, the storage circuitry 118 may store other programs and information such as data inputted via the operating unit 17 and data generated in the analysis executor 20. The storage circuitry 118 includes a recording medium that can be read by a processor, such as a magnetic or optical recording medium, or a semiconductor memory. The storage circuitry 118 is not necessarily formed of a single storage device. For example, the storage circuitry 118 may include a plurality of storage devices.

The control circuitry 110 is a processor that is a main component of the automatic analyzer 10. The control circuitry 110 executes the program stored in the storage circuitry 118 to perform one or more functions corresponding to the executed program. The control circuitry 110 may have a memory area for storing at least a portion of data stored in the storage circuitry 118. As shown in FIG. 2, the control circuitry 110 executes the program stored in the storage circuitry 118 to have, for example, a cleaning fluid discharging function 111, a probe driving function 112, a detecting function 113, a judging function 114, and a notifying function 115. In the embodiments described below, a single processor performs the cleaning fluid discharging function 111, the probe driving function 112, the detecting function 113, the judging function 114, and the notifying function 115, but this is not a limited feature. For example, a plurality of independent processors may be combined to form the control circuitry, and the respective functions may be realized by the respective processors executing programs.

In each embodiment described herein, the cleaning fluid discharging function 111 of the control circuitry 110 acts as a cleaning fluid discharger, the probe driving function 112 acts as a probe driver, the detecting function 113 acts as a detector, the judging function 114 acts as a judging unit, and the notifying function 115 acts as an alarm.

The cleaning fluid discharging function 111 controls a cleaning fluid supplier 54, which will be described later, to discharge a cleaning fluid 60 in a cleaning fluid tank 56 into a cleaning chamber 52. Every time the dispensing of a sample or a reagent using the probe 40 is finished, the probe 40 is inserted into the cleaning chamber 52. Thereafter, the cleaning fluid discharging function 111 controls the cleaning fluid supplier 54 to discharge the cleaning fluid 60 toward the probe 40 via a nozzle.

The probe driving function 112 controls the driver 120 to drive each probe 40. For example, the probe driving function 112 controls the driver 120 so that each probe 40 may be moved vertically (up and down direction) and/or horizontally.

The detecting function 113 controls a detector 410, which will be described later, of the probe 40 to detect that the probe 40 is in contact with a sample, a reagent, and/or the cleaning fluid 60. For example, the detecting function 113 controls the detector 410 to detect that the probe 40 is in contact with the sample, the reagent, and/or the cleaning fluid 60 based on a change in capacitance detected by the detector 410.

The judging function 114 is a function for judging whether a discharge position of the cleaning fluid 60 or a position of the probe 40 is within a predetermined range based on a detection result of the detector 410. Details of the judging method performed by the judging function 114 will be described later.

The notifying function 115 is a function for providing a notification (or an alarm) to the operator (user). For example, the notifying function 115 controls the output unit 15 to send a notification to the operator when the discharge position of the cleaning fluid 60 or the position of the probe 40 is not within the predetermined range.

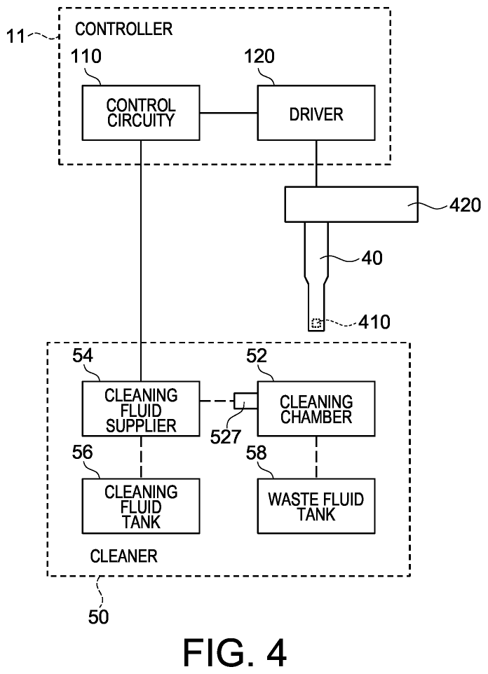

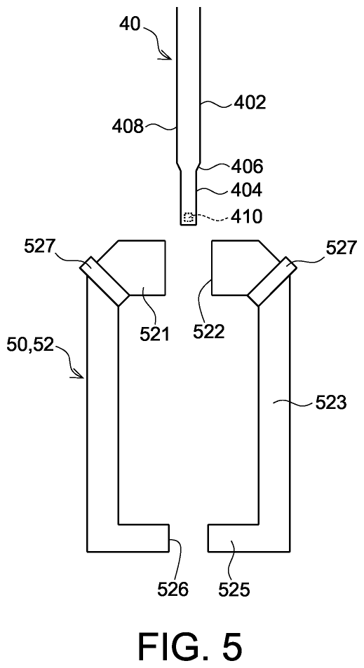

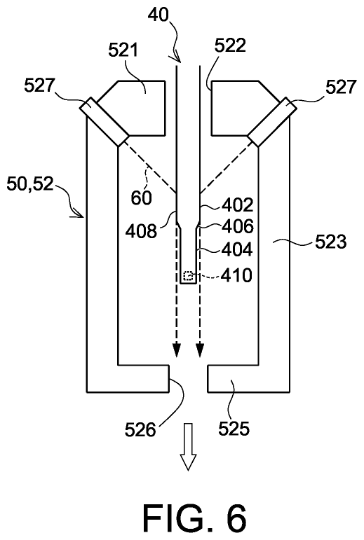

Next, the probe 40 and the cleaning mechanism (cleaner) 50 will be described below with reference to FIGS. 4 to 6. FIG. 4 is a block diagram showing an example of the configuration of the cleaner 50 included in the automatic analyzer 10. FIG. 5 illustrates an example of the cleaning chamber 52 of the cleaner 50. FIG. 6 is a diagram for explaining a method for cleaning the probe 40 in the cleaner 50.

The automatic analyzer 10 includes the probe 40, the cleaner 50, and the controller 11. In the illustrated examples, the automatic analyzer 10 includes an arm 420 for holding the probe 40. The controller 11 includes the control circuitry 110 and the driver 120.

The probe 40 has a large-diameter part 402, a small-diameter part 404, and a stepped part 406. The small-diameter part 404 is disposed on the tip portion side (lower side) of the large-diameter part 402. The stepped part 406 is disposed between the large-diameter part 402 and the small-diameter part 404. The probe 40 has an outer wall 408. In the illustrated examples, the outer wall 408 covers the outer surfaces of the large-diameter part 402, the small-diameter part 404, and the stepped part 406.

The probe 40 includes the detector 410 at its tip portion. For example, the detector 410 is an electrode. The capacitance caused to the electrode is measured. The detector 410 is capable of detecting that the probe 40 is in contact with a sample, a reagent, and/or the cleaning fluid 60 based on a change in capacitance. It is preferable that the detector 410 be at least disposed at a tip portion of the probe 40. For example, the detector 410 may be disposed over a length from the tip portion to the base of the probe 40.

As shown in FIG. 4, the probe 40 is disposed at an end portion of the arm 420. For example, a rotation shaft and a nut member are provided to the base of the arm 420. A screw member is screwed into the nut member.

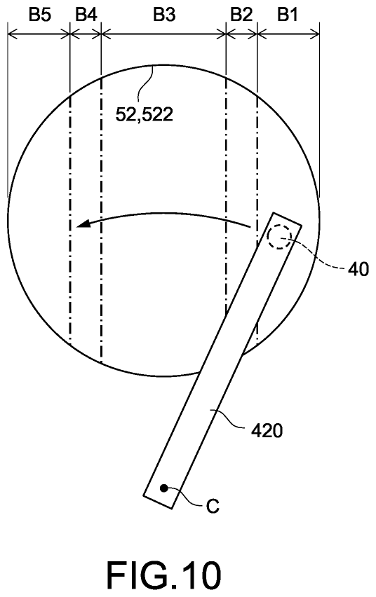

The driver 120 rotates the arm 420 around a rotation shaft C (see FIG. 10) by driving a motor to move the probe 40 around an arc path. Furthermore, the driver 120 causes the probe 40 to move upward or downward by rotating the screw member in the forward/backward direction relative to the nut member.

Based on the degree of rotations of the screw member, the control circuitry 110 judges the height (position in the vertical direction) of the probe 40, and changes the rotation speed of the screw member to control the movement speed of the probe 40. The movement of the probe 40 is controlled and performed by the probe driving function 112 of the control circuitry 110.

The cleaner 50 includes the cleaning chamber 52, the cleaning fluid supplier 54, the cleaning fluid tank 56, and a waste fluid tank 58.

The cleaning chamber 52 is capable of housing the tip portion of the probe 40. The tip portion of the probe 40 is cleaned in the cleaning chamber 52. The cleaning chamber 52 has a substantially cylindrical shape, and includes a ceiling part 521 having a substantially circular shape, a wall part 523 surrounding the circumference of the ceiling part 521, a bottom part 525 having a substantially circular shape, and nozzles 527.

A through-hole 522 is formed at a central portion of the ceiling part 521, through which the probe 40 passes in the vertical direction. As shown in FIG. 6, after being moved to a position above the through-hole 522 by the driver 120, the probe 40 is moved in the vertical direction.

Two nozzles 527 are disposed at upper end portions of the wall part 523 (or portions on the circumference of the ceiling part 521). The nozzles 527 are configured to discharge (spray) the cleaning fluid 60 from opposite directions. As shown in FIG. 6, when the cleaning fluid 60 discharged from each nozzle 527 in a diagonally downward direction hits the outer wall 408 of the probe 40, if some droplets adhere to a portion of the outer wall 408 below the position where the cleaning fluid 60 hits, the cleaning fluid 60 flowing downward along the outer wall 408 may wash out the droplets. Therefore, the droplets are not left on the outer wall 408.

For example, the cleaning fluid supplier 54 has a flow path that guides the cleaning fluid 60 from the cleaning fluid tank 56 to the nozzles 527, an electromagnetic valve for opening or closing the flow path, and a pump for supplying the cleaning fluid 60 from the cleaning fluid tank 56 to the nozzles 527.

The cleaning fluid tank 56 stores the cleaning fluid 60 used for the cleaning. The cleaning fluid 60 may be water such as pure water, or a solution including water and a cleaning material. The cleaning fluid tank 56 is in communication with the cleaning fluid supplier 54 via the flow path.

As shown in FIG. 6, the bottom part 525 of the cleaning chamber 52 has a discharge port 526. The cleaning fluid 60 used for the cleaning becomes a waste fluid, and is guided to the waste fluid tank 58 via the discharge port 526.

The controller 11 controls the cleaning fluid supplier 54. In particular, the controller 11 controls the starting and the stopping of the pump of the cleaning fluid supplier 54. The controller 11 also controls the opening and the closing of the electromagnetic valve of the cleaning fluid supplier 54. Furthermore, the controller 11 detects the position of the probe 40 based on the rotation rate of the motor of the driver 120, by referring to the correspondence relationship between the rotation rate the rotation angle of the motor. The controller 11 controls the electromagnetic valve to start the discharging of the cleaning fluid 60 from the nozzles 527 when the probe 40 is suitably disposed in the cleaning chamber 52. The discharging of the cleaning fluid 60 is controlled and performed by the cleaning fluid discharging function 111 of the control circuitry 110.

If the discharge height of the cleaning fluid 60 in the cleaner 50 is too high, the cleaning fluid 60 that hits the probe 40 may splash out of the cleaning chamber 52 and adhere to surrounding devices, which may result in failures of the surrounding devices. If the discharge height is too low, the sample or the reagent adhering to the probe 40 may not be completely removed, and the sample or the reagent left on the outer surface of the probe 40 may be mixed into a sample or a reagent that is dispensed next. Therefore, the discharge height of the cleaning fluid 60 in the cleaner 50 needs to be adjusted to be within a suitable range. The discharge height of the cleaning fluid 60 may be said to be the height at which the discharged cleaning fluid 60 hits the probe 40.

If the discharge width (spray width) of the cleaning fluid 60 in the cleaner 50 is too large (too wide), the “wiping effect” is not suitably obtained on the outer wall 408 of the probe 40, and droplets of the cleaning fluid 60 may be left on the outer wall 408. The “wiping effect” means that when the cleaning fluid 60 sequentially flows down on the outer wall 408, the cleaning fluid 60 is totally pulled down, which prevents droplets of the cleaning fluid 60 from being left on the outer wall 408. In order to suitably cause the “wiping effect,” a suitable amount of the cleaning fluid 60 needs to contact the outer wall 408 of the probe 40 at a suitable flow rate. If the discharge width (spray width) of the cleaning fluid 60 is too large, the amount and the flow rate of the cleaning fluid 60 may go outside the suitable ranges. If the discharge width (spray width) of the cleaning fluid 60 in the cleaner 50 is too small (too narrow), the sample or the reagent adhering to the probe 40 may not be completely removed, and the sample or the reagent left on the outer wall 408 may be mixed into a sample or a reagent dispensed next. Therefore, the discharge width of the cleaning fluid 60 needs to be adjusted to be within a suitable range in the cleaner 50.

The automatic analyzer 10 described herein uses the detector 410 disposed to the probe 40 to detect the height at which the discharged cleaning fluid 60 hits the probe 40 and/or the discharge width of the cleaning fluid 60. The automatic analyzer 10 judges the state of the cleaner 50 based on the detection result.

Embodiments of the disclosure will be described below with reference to the accompanying drawings.

### First Embodiment

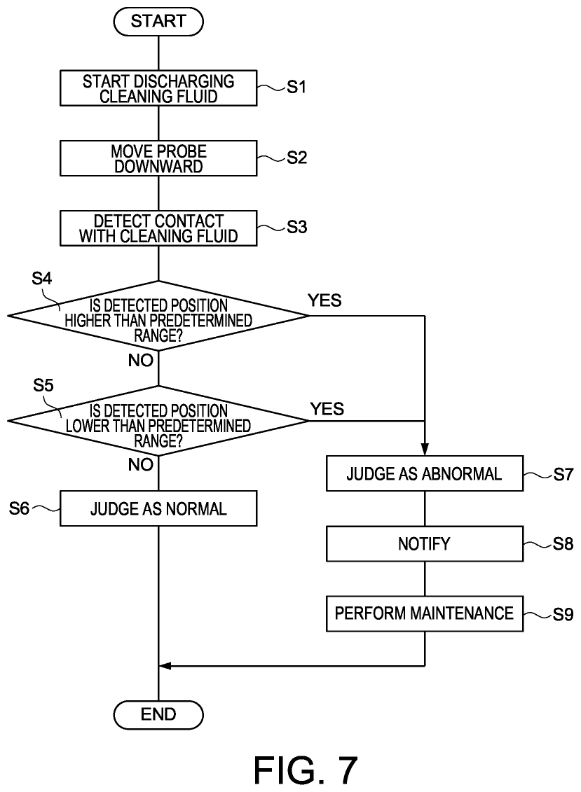

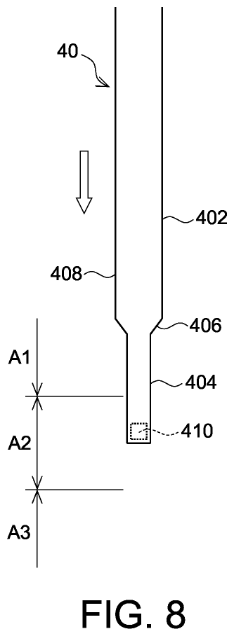

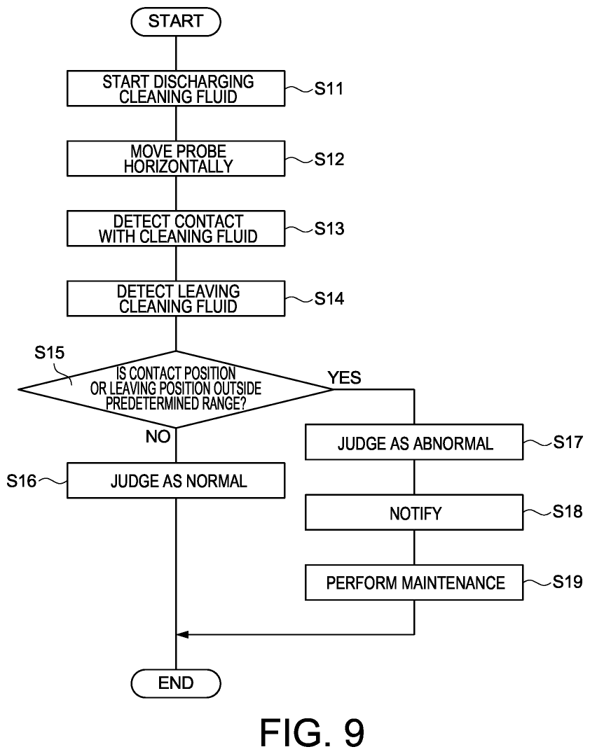

A first embodiment will be described below with reference to FIGS. 7 to 10. FIG. 7 is a flowchart showing an operation for detecting a cleaning fluid discharge position in the vertical direction according to the first embodiment. FIG. 8 is a diagram for explaining the operation for detecting the cleaning fluid discharge position in the vertical direction according to the first embodiment. FIG. 9 is a flowchart showing an operation for detecting the cleaning fluid discharge position in the horizontal direction according to the first embodiment. FIG. 10 is a diagram for explaining the detection of the cleaning fluid discharge position in the horizontal direction according to the first embodiment.

In the first embodiment, while the cleaning fluid 60 is being discharged from the nozzles 527, the probe 40 is moved in the vertical or the horizontal direction to detect the position of the cleaning fluid 60. As compared to the second embodiment described later, the detection speed in the first embodiment is faster since the position of the cleaning fluid 60 is detected while the probe 40 is moved vertically or horizontally.

A method for detecting a position in the vertical direction of the cleaning fluid 60 by vertically moving the probe 40 will be described below with reference to FIGS. 7 and 8. First, the discharge of the cleaning fluid 60 is started (step S1). The controller 11 controls the starting and the stopping of the pump and the opening and the closing of the electromagnetic valve of the cleaning fluid supplier 54 to discharge the cleaning fluid 60. The discharge of the cleaning fluid 60 is controlled and performed by the cleaning fluid discharging function 111 of the control circuitry 110.

Next, the probe 40 is horizontally moved to be located above the through-hole 522 of the cleaning chamber 52. Thereafter, the probe 40 is vertically moved (downward) to be inserted into the cleaning chamber 52 via the through-hole 522 (step S2). The movement of the probe 40 is controlled and performed by the probe driving function 112 of the control circuitry 110. At this time, the controller 11 continues the detection by the detector 410 of whether the probe 40 is in contact with the cleaning fluid 60.

When the tip portion of the probe 40 reaches the cleaning fluid 60, the detector 410 detects that the tip portion is in contact with the cleaning fluid 60 (step S3). For example, the detector 410 detects that the probe 40 is in contact with the cleaning fluid 60 based on a change in capacitance measured by the detector 410. The detection is controlled and performed by the detecting function 113 of the control circuitry 110.

After the detection that the probe 40 is in contact with the cleaning fluid 60, the controller 11 calculates the height (detected position) of the probe 40. For example, the controller 11 calculates the detected position of the probe 40 based on the degree of rotations of the screw member of the driver 120, and judges whether the detected position is higher than the predetermined range (step S4).

A suitable range of the detected position will be described below with reference to FIG. 8. In FIG. 8, the probe 40 is viewed from the horizontal direction. A region A1, a region A2, and a region A3 are set, which are vertically arranged in this order. The region A2 defines a predetermined range in the vertical direction (height direction). The region A1 is above the predetermined range, and the region A3 is below the predetermined range. In the first embodiment, the discharge height of the cleaning fluid 60 is judged to be suitable when the detected position in the vertical direction is within the region A2. If the detected position is in the region A1, the discharge height of the cleaning fluid 60 is judged to be too high. If the detected position is in the region A3, the discharge height of the cleaning fluid 60 is judged to be too low.

If the controller 11 judges that the detected position is higher than the predetermined range in the step S4 (“YES” in step S4), the controller 11 judges that the discharge height of the cleaning fluid 60 is abnormal (step S7). If the controller 11 judges that the detected position is not higher than the predetermined range in step S4 (“NO” in step S4), the controller 11 then judges whether the detected position is lower than the predetermined range (step S5). If the controller 11 judges that the detected position is lower than the predetermined range in step S5 (“YES” in step S5), the controller 11 judges that the discharge height of the cleaning fluid 60 is abnormal (step S7). If the controller 11 judges that the detected position is not lower than the predetermined range in step S5 (“NO” in step S5), the controller 11 judges that the discharge height of the cleaning fluid 60 is normal (step S6). The judgments in steps S4 to S7 are controlled and performed by the judging function 114 of the control circuitry 110.

If the controller 11 judges that the discharge height of the cleaning fluid 60 is abnormal in step S7, the controller 11 sends a notification to the operator (step S8). In step S8, the notification to the operator may be sent in the form of a print output from the printing unit 151, a display on the display 152, an audio output from a speaker, or the like. The notification to the operator may also be sent to an information terminal used by the operator via the online unit 153. The information terminal may be a personal computer, a mobile phone, a smartphone, a tablet terminal, or the like.

Upon receipt of the notification, the operator may adjust the discharge height of the cleaning fluid 60. The controller 11 may perform a maintenance operation automatically or by receiving an instruction from the operator (step S9). Specifically, the controller 11 may adjust the orientations of the nozzles 527 based on the detected position detected in step S3 so that the direction in which the cleaning fluid 60 is discharge is adjusted.

A method for detecting a position in the horizontal direction of the cleaning fluid 60 by horizontally moving the probe 40 will be described below with reference to FIGS. 9 and 10. First, the discharge of the cleaning fluid 60 is started (step S11). The discharge may be performed in the same manner as step S1.

Next, the controller 11 horizontally moves the probe 40 to be located above the through-hole 522 of the cleaning chamber 52. Thereafter, the controller 11 vertically moves (downward) the probe 40 to be inserted into the cleaning chamber 52 via the through-hole 522 (step S2). The controller 11 then horizontally moves the probe 40 in the through-hole 522 of the cleaning chamber 52 (step S12). The movement of the probe 40 is controlled and performed by the probe driving function 112 of the control circuitry 110. At this time, the controller 11 continues the detection by the detector 410 of whether the probe 40 is in contact with the cleaning fluid 60. In the first embodiment, the horizontal movement of the probe 40 is performed by rotating the arm 420 around the rotation shaft C, but it is not limited to this method. The horizontal movement may be performed by linearly moving the probe 40 in the horizontal direction by other means.

When the tip portion of the probe 40 reaches the cleaning fluid 60, the detector 410 detects that the tip portion is in contact with the cleaning fluid 60 (step S13). The detection is controlled and performed by the detecting function 113 of the control circuitry 110.

The controller 11 continues the horizontal movement of the probe 40. When the tip portion of the probe 40 leaves the cleaning fluid 60, i.e., when the tip portion of the probe 40 is no longer in contact with the cleaning fluid 60, the detector 410 detects that the probe 40 leaves the cleaning fluid 60 (step S14). The detection is controlled and performed by the detecting function 113 of the control circuitry 110.

If it is detected that the probe 40 is in contact with the cleaning fluid 60 or that the probe 40 leaves the cleaning fluid 60, the controller 11 calculates the horizontal position (detected position) of the probe 40. For example, the horizontal position of the probe 40 is calculated based on the rotation rate of the motor of the driver 120 by referring to the correspondence relationship between the rotation rate and the rotation angle of the motor.

The controller 11 judges whether the contact position or the leaving position of the probe 40 relative to the cleaning fluid 60 is outside a predetermined range (step S15).

The suitable range for the contact position and the leaving position will be described below with reference to FIG. 10. FIG. 10 shows that the probe 40, the arm 420, the cleaning chamber 52, and the through-hole 522 are vertically viewed from above. In FIG. 10, regions B1, B2, B3, B4 and B5 are set from right to left in the horizontal direction. The region B2 defines a suitable range for the contact position between the probe 40 and the cleaning fluid 60. The region B4 defines a suitable region for the leaving position where the probe 40 leaves the cleaning fluid 60. Therefore, in the first embodiment, when the contact position between the probe 40 and the cleaning fluid 60 is in the region B2, the contact position is judged to be suitable. When the leaving position where the probe 40 leaves the cleaning fluid 60 is in the region B4, the leaving position is judged to be suitable. If the contact position and the leaving position are judged to be suitable in step S15, the controller 11 judges that the contact position and the leaving position are normal (step S16).

If the contact position is judged to be in any of the regions B1, B3, B4, and B5 in step S15, i.e., if the contact position is outside the predetermined range (“YES” in step S15), the controller 11 judges that the position to contact the cleaning fluid 60 is abnormal (step S17). If the leaving position is judged to be in any of the regions B1, B2, B3, and B5, i.e., if the leaving position is judged to be outside the predetermined range (“YES” in step S15), the controller 11 judges that the leaving position from the cleaning fluid 60 is abnormal (step S17). If the contact position is within the region B1 or the leaving position is within the region B5, the discharge width of the cleaning fluid 60 may be too large. If the contact position is in any of the regions B3, B4, and B5, or the leaving position is in any of the regions B1, B2, and B3, the discharge width of the cleaning fluid 60 may be too small. The judgments in steps S15 to S17 are controlled and performed by the judging function 114 of the control circuitry 110.

If the contact position and/or the leaving position with respect to the cleaning fluid 60 is judged to be abnormal in step S17, the controller 11 sends a notification to the operator (step S18). Step S18 may be performed in the same manner as step S8 described above.

Upon receipt of the notification, the operator may adjust the discharge width of the cleaning fluid 60. The controller 11 may also perform a maintenance operation automatically or by receiving an instruction from the operator (step S19). Specifically, the controller 11 may adjust the discharge width of the cleaning fluid 60 based on the contact position or the leaving position detected in steps S13 and S14.

### Second Embodiment

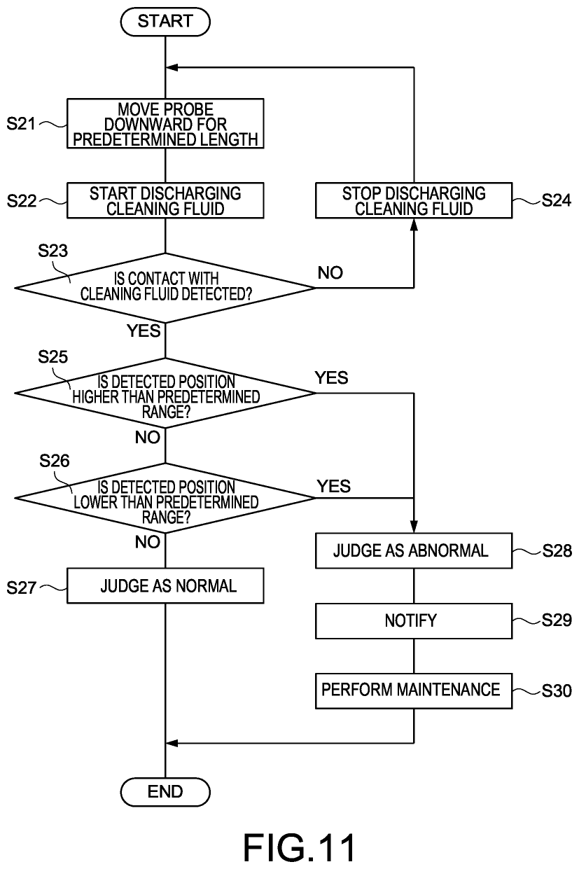

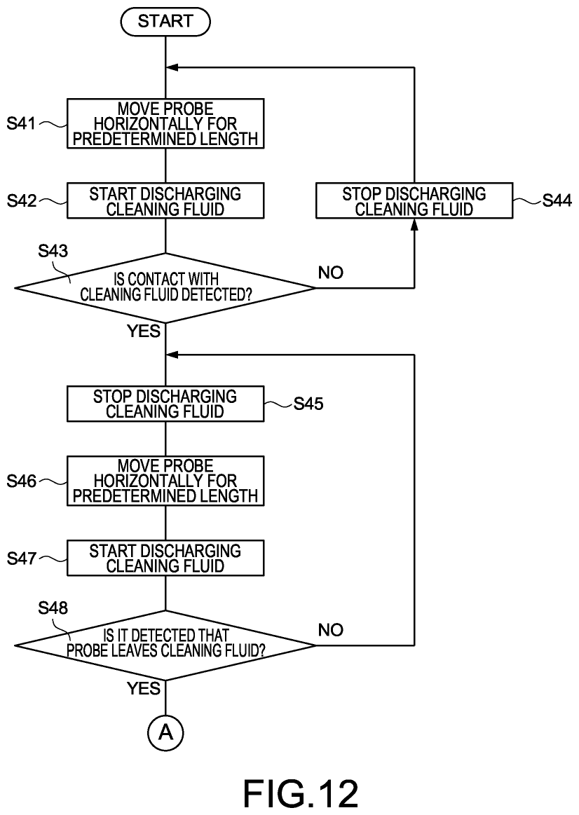

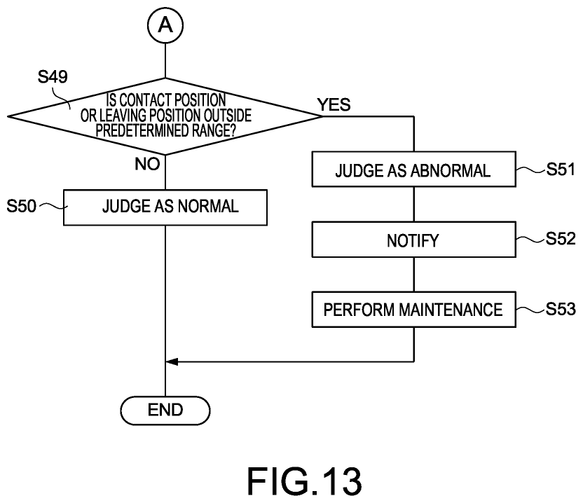

A second embodiment will be described below with reference to FIGS. 11 to 13. FIG. 11 is a flowchart showing an operation for detecting the cleaning fluid discharge position in the vertical direction according to the second embodiment. FIGS. 12 and 13 are flowcharts showing an operation for detecting the cleaning fluid discharge position in the horizontal direction according to the second embodiment.

In the second embodiment, the probe 40 is moved vertically or horizontally for a predetermined length, and after the probe 40 is stopped, the cleaning fluid 60 is discharged from the nozzles 527 and whether the contact between the probe 40 and the cleaning fluid 60 is detected is judged. If the contact between the probe 40 and the cleaning fluid 60 is not detected, the discharge of the cleaning fluid 60 is suspended. Thereafter, the probe 40 is further moved vertically or horizontally for a predetermined length, and after the probe 40 is stopped, the cleaning fluid 60 is discharged from the nozzles 527 again and whether the contact between the probe 40 and the cleaning fluid 60 is detected is judged again. The above process is repeated until the contact between the probe 40 and the cleaning fluid 60 is detected. Although the detection speed is slower in the second embodiment than the first embodiment, the detection may be performed without receiving the influence of noise caused by vibrations etc. during the movement of the probe 40 since the contact between the probe 40 and the cleaning fluid 60 is detected when the probe 40 is stopped. Therefore, the contact between the probe 40 and the cleaning fluid 60 may be detected accurately. A method for detecting the position of the cleaning fluid 60 according to the second embodiment will be described below.

A method for detecting the position of the cleaning fluid 60 in the vertical direction by vertically moving the probe 40 will be described below with reference to FIG. 11. First, the probe 40 is horizontally moved to a position above the through-hole 522 of the cleaning chamber 52. Thereafter, the probe 40 is vertically moved (downward) to be inserted into the cleaning chamber 52 via the through-hole 522 (step S21). The controller 11 then stops the probe 40. The moving and the stopping of the probe 40 are controlled and performed by the probe driving function 112 of the control circuitry 110.

The cleaning fluid 60 is then discharged (step S22). The controller 11 controls the starting and the stopping of the pump and the opening and the closing of the electromagnetic valve of the cleaning fluid supplier 54 to discharge the cleaning fluid 60. The discharge of the cleaning fluid 60 is controlled and performed by the cleaning fluid discharging function 111 of the control circuitry 110.

Next, the controller 11 judges whether the tip portion of the probe 40 is in contact with the cleaning fluid 60 (step S23). If the tip portion of the probe 40 reaches the cleaning fluid 60, the detector 410 detects that the tip portion is in contact with the cleaning fluid 60. The detection is controlled and performed by the detecting function 113 of the control circuitry 110.

If the probe 40 is in contact with the cleaning fluid 60 (“YES” in step S23), the process proceeds to step S25. If the probe 40 is not in contact with the cleaning fluid 60 (“NO” in step S23), the controller 11 stops the discharging of the cleaning fluid 60 (step S24). The stopping of the discharge of the cleaning fluid 60 is controlled and performed by the cleaning fluid discharging function 111 of the control circuitry 110. Thereafter, the process returns to step S21, and the probe 40 is vertically moved (downward) further for a predetermined length and stopped. Steps S21 to S24 are repeated until the controller 11 detects that the tip portion of the probe 40 is in contact with the cleaning fluid 60.

When it is detected that the probe 40 is in contact with the cleaning fluid 60, the controller 11 calculates the height (detected position) of the probe 40. For example, the controller 11 calculates the detected position of the probe 40 based on the degree of rotations of the screw member of the driver 120, and judges whether detected position is higher than the predetermined range (step S25). The suitable range of the detected position is the same as that described above with reference to FIG. 8. Therefore, the explanation thereof is omitted.

If the controller 11 judges that detected position is higher than the predetermined range in step S25 (“YES” in step S25), the controller 11 judges that the discharge height of the cleaning fluid 60 is abnormal (step S28). If the controller 11 judges that the detected position is not higher than the predetermined range in step S25 (“NO” in step S25), the controller 11 then judges whether the detected position is lower than the predetermined range (step S26). If the controller 11 judges that the detected position is lower than the predetermined range in step S26 (“YES” in step S26), the controller 11 judges that the discharge height of the cleaning fluid 60 is abnormal (step S28). If the controller 11 judges that the detected position is not lower than the predetermined range in step S26 (“NO” in step S26), the controller 11 judges that the discharge height of the cleaning fluid 60 is normal (step S27). The judgments in steps S25 to S28 are controlled and performed by the judging function 114 of the control circuitry 110.

If the controller 11 judges that the discharge height of the cleaning fluid 60 is abnormal in step S28, the controller 11 sends a notification to the operator (step S29). Step S29 may be performed in the same manner as step S8 in the first embodiment.

Upon receipt of the notification, the operator may adjust the discharge height of the cleaning fluid 60. The controller 11 may perform a maintenance operation automatically or by receiving an instruction from the operator (step S30). Step S30 may be performed in the same manner as step S9 in the first embodiment.

A method for detecting the position of the cleaning fluid 60 in the horizontal direction by horizontally moving the probe 40 will now be described with reference to FIGS. 12 and 13.

First, the controller 11 horizontally moves the probe 40 to a position above the through-hole 522 of the cleaning chamber 52. Thereafter, the controller 11 vertically moves (downward) the probe 40 to insert the probe 40 to the cleaning chamber 52 via the through-hole 522. The controller 11 then horizontally moves the probe 40 in the through-hole 522 of the cleaning chamber 52 (step S41). Thereafter, the controller 11 stops the probe 40. The moving and the stopping of the probe 40 are controlled and performed by the probe driving function 112 of the control circuitry 110.

Next, the cleaning fluid 60 is discharged (step S42). Step S42 may be performed in the same manner as step S22 described above.

Next, the controller 11 judges whether the tip portion of the probe 40 is in contact with the cleaning fluid 60 (step S43). If the tip portion of the probe 40 reaches the cleaning fluid 60, the detector 410 detects that the tip portion is in contact with the cleaning fluid 60. The detection is controlled and performed by the detecting function 113 of the control circuitry 110.

If the probe 40 is in contact with the cleaning fluid 60 (“YES” in step S43), the process proceeds to step S45. If the probe 40 is not in contact with the cleaning fluid 60 (“NO” in step S43), the controller 11 stops the discharge of the cleaning fluid 60 (step S44). The stopping of the discharge of the cleaning fluid 60 is controlled and performed by the cleaning fluid discharging function 111 of the control circuitry 110. Thereafter, the process returns to step S41, and the probe 40 is horizontally moved further for a predetermined length and stopped. The controller 11 repeats steps S41 to S44 until detecting that the tip portion of the probe 40 is in contact with the cleaning fluid 60.

When it is detected that the probe 40 is in contact with the cleaning fluid 60, the controller 11 calculates the height (detected position) of the probe 40. For example, the controller 11 calculates the detected position of the probe 40 based on the degree of rotations of the screw member of the driver 120.

The controller 11 then stops the discharge of the cleaning fluid 60 (step S45). The stopping of the discharge of the cleaning fluid 60 is controlled and performed by the cleaning fluid discharging function 111 of the control circuitry 110.

Thereafter, the probe 40 is moved further in the horizontal direction and stopped (step S46).

Next, the cleaning fluid 60 is discharged (step S47). Step S47 may be performed in the same manner as step S22 described above.

The controller 11 then judges whether the tip portion of the probe 40 leaves the cleaning fluid 60 (step S48). When the tip portion of the probe 40 leaves the cleaning fluid 60, the detector 410 detects that the tip portion of the probe 40 is no longer in contact with the cleaning fluid 60. The detection is controlled and performed by the detecting function 113 of the control circuitry 110.

If the tip portion of the probe 40 leaves the cleaning fluid 60 (“YES” in step S48), the process proceeds to step S49 shown in FIG. 13. If the probe 40 has not left the cleaning fluid 60 (“NO” in step S48), the process returns to step S45, and the controller 11 stops the discharging of the cleaning fluid 60. The controller 11 then moves the probe 40 further in the horizontal direction for the predetermined length and stops the probe 40. The controller 11 repeats step S45 to S48 until the leaving of the tip portion of the probe 40 from the cleaning fluid 60 is detected.

In step S49, the controller 11 judges whether the contact position or the leaving position of the probe 40 and the cleaning fluid 60 are outside a predetermined range. Step S49 may be performed in the same manner as step S15 described above. The suitable range for the contact position or the leaving position is the same as that described above with reference to FIG. 10. Therefore, the suitable range is not explained here.

If the contact position or the leaving position is judged to be suitable in step S49, the controller 11 judges that the contact position and the leaving position are normal (step S50). If the contact position and/or the leaving position is judged to be outside the suitable range in step S49 (“YES” in step S49), the controller 11 judges that the contact position and/or the leaving position with respect to the cleaning fluid 60 is abnormal (step S51).

If the contact position and/or the leaving position with respect to the cleaning fluid 60 is abnormal in step S51, the controller 11 sends a notification to the operator (step S52). Step S52 may be performed in the same manner as step S8 described above.

Upon receipt of the notification, the operator may adjust the discharge width of the cleaning fluid 60. The controller 11 may also perform a maintenance operation automatically or by receiving an instruction from the operator (step S53). Specifically, the controller 11 may adjust the discharge width of the cleaning fluid 60 based on the contact position and the leaving position detected in steps S13 and S14.

### Third Embodiment

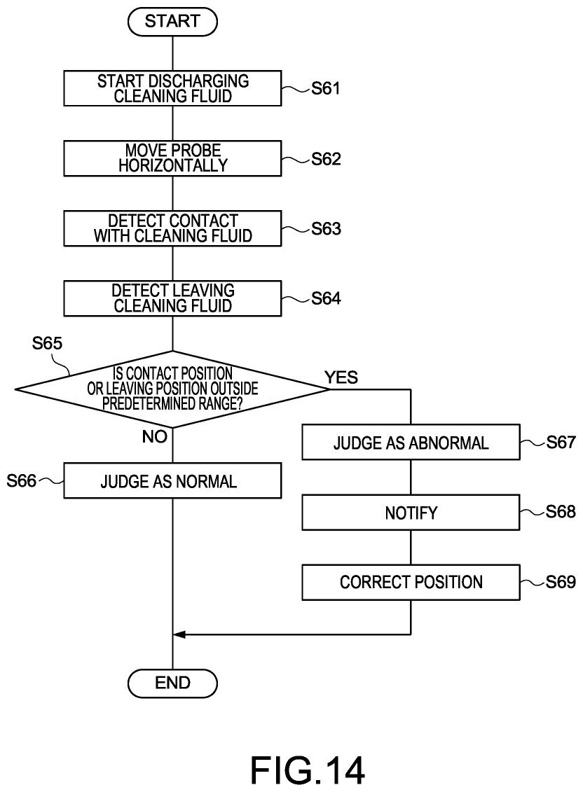

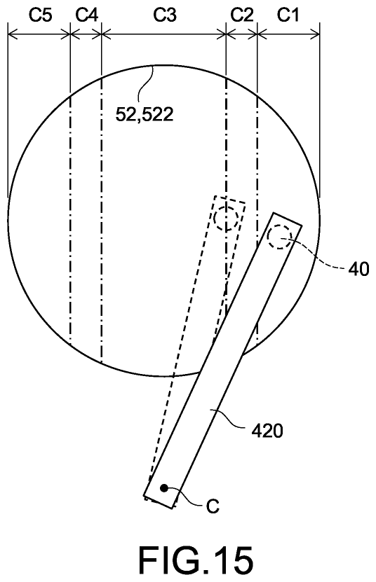

A third embodiment will be described below with reference to FIGS. 14 and 15. FIG. 14 is a flowchart showing a process for detecting a position of a probe in the horizontal direction according to the third embodiment. FIG. 15 is a diagram for explaining the detection of the probe position in the horizontal direction according to the third embodiment.

A method for detecting misalignment of the probe 40 according to the third embodiment, if the discharge width of the cleaning fluid 60 is normal, will be described below. First, the cleaning fluid 60 is discharged (step S61). The discharge of the cleaning fluid 60 may be performed in the same manner as step S1 described above.

The controller 11 then moves the probe 40 in the horizontal direction to a position above the through-hole 522 of the cleaning chamber 52. Thereafter, the controller 11 vertically moves the probe 40 (downward) to insert the probe 40 into the cleaning chamber 52 via the through-hole 522. The controller 11 then horizontally moves the probe 40 in the through-hole 522 of the cleaning chamber 52 (step S62). Step S62 may be performed in the same manner as step S12 described above.

When the tip portion of the probe 40 reaches the cleaning fluid 60, the detector 410 detects that the tip portion of the probe 40 is in contact with the cleaning fluid 60 (step S63). The detection is controlled and performed by the detecting function 113 of the control circuitry 110.

The controller 11 continues the horizontal movement of the probe 40. When the tip portion of the probe 40 leaves the cleaning fluid 60, i.e., when the tip portion of the probe 40 is no longer in contact with the cleaning fluid 60, the detector 410 detects that the probe 40 leaves the cleaning fluid 60 (step S64). The detection is controlled and performed by the detecting function 113 of the control circuitry 110.

If it is detected that the probe 40 is in contact with the cleaning fluid 60 or that the probe 40 leaves the cleaning fluid 60, the controller 11 calculates the horizontal position (detected position) of the probe 40. For example, the horizontal position of the probe 40 is calculated based on the rotation rate of the motor of the driver 120 by referring to the correspondence relationship between the rotation rate and the rotation angle of the motor.

The controller 11 then judges whether the contact position or the leaving position between the probe 40 and the cleaning fluid 60 is outside a predetermined range (step S65).

It is assumed in the third embodiment that the discharge width of the cleaning fluid 60 is normal. With reference to FIG. 15, a suitable range of the contact position and the leaving position will be described. FIG. 15 shows the probe 40, the arm 420, the cleaning chamber 52, and the through-hole 522 viewed from above in the vertical direction. Regions C1, C2, C3, C4 and C5 are set in the horizontal direction from right to left in FIG. 15. The region C2 defines a predetermined range for the contact position of the probe 40 and the cleaning fluid 60. The region C4 defines a predetermined range for the leaving position of the probe 40 and the cleaning fluid 60. In the third embodiment, if the contact position of the probe 40 and the cleaning fluid 60 is in the region C2 and the leaving position of the probe 40 and the cleaning fluid 60 is in the region C4, the position of the probe is judged to be suitable. If the probe position is judged to be suitable in step S65, the controller 11 judges that the probe position is normal (step S66).

If the contact position is judged to be in any of the regions C1, C3, C4, and C5 in step S65, i.e., if the contact position is outside the predetermined range (“YES” in step S65), the controller 11 judges that the probe position is abnormal (step S67). If the leaving position is judged to be in any of the regions C1, C2, C3, and C5, i.e., if the leaving position is judged to be outside the predetermined range (“YES” in step S65), the controller 11 judges that the probe position is abnormal (step S67). If the probe position is judged to be abnormal, there is a possibility that the position of the probe 40 is misaligned.

If the probe position is judged to be abnormal in step S67, the controller 11 sends a notification to the operator (step S68). Step S68 may be performed in the same manner as step S8 described above.

Upon receipt of the notification, the operator may adjust the probe position. The controller 11 may perform a probe position adjustment automatically or by receiving an instruction from the operator (step S69). Specifically, the controller 11 may adjust the probe position based on the contact position and the leaving position detected in step S63 and step S64.

An automatic analyzer 10 according to an embodiment is:
(1) automatic analyzer 10 including:
   a probe 40 configured to perform sucking and discharging of a liquid, the probe 40 including a detector 410 configured to detect a contact with the liquid;
   a cleaner 50 configured to clean an outer wall 408 of the probe 40 with a cleaning fluid 60; and
   a controller 11 configured to cause the detector 410 to perform a detection during cleaning by the cleaner 50, and judge a state of the cleaner 50 based on a result of the detection.

An automatic analyzer 10 according to an embodiment is:
(2) the automatic analyzer 10 according to (1), wherein the controller 11 detects a position in a vertical direction of the cleaning fluid 60 by vertically moving the probe 40.

An automatic analyzer 10 according to an embodiment is:
(3) the automatic analyzer 10 according to (2), wherein the controller 11 sends a notification when the position in the vertical direction of the cleaning fluid 60 is outside a predetermined range.

An automatic analyzer 10 according to an embodiment is:
(4) the automatic analyzer 10 according to any one of (1) to (3), wherein the controller 11 detects a position in a horizontal direction of the cleaning fluid 60 by horizontally moving the probe 40.

An automatic analyzer 10 according to an embodiment is:
(5) the automatic analyzer 10 according to (4), wherein the controller 11 sends a notification when the position in the horizontal direction of the cleaning fluid 60 is outside a predetermined range.

An automatic analyzer 10 according to an embodiment is:
(6) the automatic analyzer 10 according to any one of (1) to (5), wherein the controller 11 performs a maintenance of the cleaner 50 based on the state of the cleaner 50.

An automatic analyzer 10 according to an embodiment is:
(7) an automatic analyzer 10 including:
   a probe 40 configured to perform sucking and discharging of a liquid, the probe 40 including a detector 410 configured to detect a contact with the liquid;
   a cleaner 50 configured to clean an outer wall 408 of the probe 40 with a cleaning fluid 60; and
   a controller 11 configured to cause the detector 410 to perform a detection during cleaning by the cleaner 50, and judge a position of the probe 40 based on a result of the detection.

An automatic analyzer 10 according to an embodiment is:
(8) the automatic analyzer 10 according to (7), wherein the controller 11 sends a notification when the position of the probe 40 is outside the predetermined range.

An automatic analyzer 10 according to an embodiment is:
(9) the automatic analyzer 10 according to (7) or (8), wherein controller 11 adjusts the position of the probe 40 when the position of the probe 40 is outside the predetermined range.

The term “processor” in the above descriptions means circuitry such as a central processing unit (CPU), a graphics processing unit (GPU), an application specific integrated circuit (ASIC), a programmable logic device like a simple programmable logic device (SPLD) or a complex programmable logic device (CPLD), and a field programmable gate array (FPGA). If the processor is a CPU, for example, the processor performs a function by reading a program stored in storage circuitry. If the processor is an ASIC, the processor has the function realized as a logic circuit and directly included in the circuitry of the processor instead of being stored in the storage circuitry. The processor of one or more embodiments is not limited to be a single circuit, but may be a combination of a plurality of independent circuits formed as a single processor to perform one or more processing functions. The components shown in FIG. 1 may be implemented to a single processor to perform processing functions.

While certain embodiments and their modifications have been described, these embodiments and modifications have been presented by way of example only, and are not intended to limit the scope of the inventions. Indeed, a variety of other forms such as omissions, substitutions, changes and combinations may be made in the embodiments and modifications without departing from the spirit of the inventions. Such embodiments and modifications are intended to be covered by the scope and spirit of the inventions as well as the claimed inventions and their equivalents.

1. An automatic analyzer comprising:
a probe configured to perform sucking and discharging of a liquid, the probe including a detector configured to detect a contact with the liquid;
a cleaner configured to clean an outer wall of the probe with a cleaning fluid; and
a controller configured to cause the detector to perform a detection during cleaning by the cleaner, and judge a state of the cleaner based on a result of the detection.

2. The automatic analyzer according to claim 1, wherein the controller detects a position in a vertical direction of the cleaning fluid by vertically moving the probe.

3. The automatic analyzer according to claim 2, wherein the controller sends a notification when the position in the vertical direction of the cleaning fluid is outside a predetermined range.

4. The automatic analyzer according to claim 1, wherein the controller detects a position in a horizontal direction of the cleaning fluid by horizontally moving the probe.

5. The automatic analyzer according to claim 4, wherein the controller sends a notification when the position in the horizontal direction of the cleaning fluid is outside a predetermined range.

6. The automatic analyzer according to claim 1, wherein the controller performs a maintenance of the cleaner based on the state of the cleaner.

7. An automatic analyzer comprising:
a probe configured to perform sucking and discharging of a liquid, the probe including a detector configured to detect a contact with the liquid;
a cleaner configured to clean an outer wall of the probe with a cleaning fluid; and
a controller configured to cause the detector to perform a detection during cleaning by the cleaner, and judge a position of the probe based on a result of the detection.

8. The automatic analyzer according to claim 7, wherein the controller sends a notification when the position of the probe is outside a predetermined range.

9. The automatic analyzer according to claim 7, wherein the controller adjusts the position of the probe when the position of the probe is outside the predetermined range.
